(19) United States
(12) Patent Application Publication
(10) Pub. No.: US 2025/0391424 A1
(43) Pub. Date: Dec. 25, 2025

(54) SYSTEM AND METHOD FOR DETECTING SYNTHETIC SPEECH USING ANOMALY DETECTION TECHNIQUES

(71) Applicant: Corsound AI Ltd, Tel Aviv (IL)

(72) Inventor: Roman FRENKEL, Tel Aviv (IL)

(73) Assignee: Corsound AI Ltd, Tel Aviv (IL)

(21) Appl. No.: 18/947,036

(22) Filed: Nov. 14, 2024

Related U.S. Application Data
(60) Provisional application No. 63/663,708, filed on Jun. 25, 2024.

(51) Int. Cl. G10L 25/69; G10L 15/00; G10L 17/04; G10L 17/06

(52) U.S. Cl. CPC G10L 25/69; G10L 15/005; G10L 17/04; G10L 17/06

(57) ABSTRACT

System and method for detecting synthetic speech may include, using a processor: in a training phase: generating an embedding for each of a plurality of bona fide speech samples by providing each of the plurality of bona fide speech samples to one or more encoders; clustering the embeddings into a plurality of clusters; and determining a decision boundary for each of the plurality of clusters; during runtime: generating an embedding for an examined speech sample by providing the examined speech sample to the one or more encoders; assigning the examined speech sample to selected cluster of the plurality of clusters; and determining that the examined speech sample includes synthetic speech based on a location of the embedding of the examined speech sample with relation to the decision boundary in the selected cluster.

### CROSS-REFERENCE TO RELATED APPLICATIONS

This application claims the benefit of U.S. Provisional Application Ser. No. 63/663,708, filed Jun. 25, 2024, which is hereby incorporated by reference in its entirety.

### FIELD OF THE INVENTION

The present invention relates generally to deep fake audio samples of speech; by way of non-limiting example, a synthetic speech may be detected using anomaly detection techniques on archetypes of speakers.

### BACKGROUND

Sophisticated deep learning models for voice generation and voice cloning, e.g., generating fake speech having the voice of a real person, may produce extremely realistic synthetic speech. Malicious uses of such tools are possible and likely, posing a serious threat to individuals, organizations and to society as a whole. Speaker recognition systems exist as well; however, most voice-cloning tools today succeed in replicating the speaker voice so that often the speaker recognition systems may not be able to distinguish between real and spoofed voice.

### SUMMARY

According to embodiments of the invention, a computer-based system and method for detecting synthetic speech may include: in a training phase: (a) generating an embedding for each of a plurality of bona fide speech samples by providing each of the plurality of bona fide speech samples to one or more encoders; (b) clustering the embeddings into a plurality of clusters; and (c) determining a decision boundary for each of the plurality of clusters; during runtime: (d) generating an embedding for an examined speech sample by providing the examined speech sample to the one or more encoders; (e) assigning the examined speech sample to selected cluster of the plurality of clusters; and (f) determining that the examined speech sample includes synthetic speech based on a location of the embedding of the examined speech sample with relation to the decision boundary in the selected cluster.

According to embodiments of the invention, operation (f) may include: determining that the examined speech sample includes synthetic speech if the embedding of the examined speech sample is outside of an area enclosed by the decision boundary, and that the examined speech sample is bona fide if the embedding of the examined speech sample is within the area enclosed by the decision boundary.

According to embodiments of the invention, the one or more encoders may include two or more encoders, each trained to extract a different type of embedding, the method may include: in operation (a) combining the two or more embeddings of each of the plurality of bona fide speech samples; and in operation (d) combining the two or more embeddings of the examined speech sample.

According to embodiments of the invention, the one or more encodes may include a speaker verification encoder, a prosody extraction encoder and an audio deep fake classifier.

According to embodiments of the invention, clustering may be performed on the embeddings using a classifier.

According to embodiments of the invention, clustering may include: estimating a plurality of metaproperties of a speaker in a speech sample of the plurality of bona fide speech samples using pre-trained classifiers; and assigning each of the plurality of bona fide speech samples to clusters based on the metaproperties.

According to embodiments of the invention, assigning speech samples to clusters may include assigning speech samples with identical metaproperties to a single cluster.

According to embodiments of the invention, the metaproperties may be selected from: gender, age, skin tone, nationality, accent and location.

According to embodiments of the invention, the decision boundary may be defined by a center of the cluster and a distance radius measured from the center.

According to embodiments of the invention, the center of the cluster may be a mean of the unified embedding within the cluster, and the distance radius may be related to a mean and standard deviation (STD) of the distances of the unified embeddings within the cluster from the center of the cluster.

Embodiments of the invention may include determining a language of the speaker in the plurality of bona fide speech samples and in the examined speech sample, and repeating operations (a)-(f) for each language.

According to embodiments of the invention, a computer-based system and method for detecting synthetic speech may include: in a training phase: (a) extracting, using at least one voice encoder, at least one embedding for each of a plurality of genuine speech samples; (b) clustering the plurality of embeddings to a plurality of clusters; and (c) determining a decision boundary for each of the plurality of clusters; during runtime: (d) extracting, using the at least one voice encoder, at least one embedding for an examined speech sample; (e) assigning the examined speech sample to one or more clusters of the plurality of clusters; and (f) determining for each of the one or more clusters the examined speech sample is assigned to, whether the examined speech sample is outside or inside of an area enclosed by the decision boundary; and (g) determining whether the examined speech sample is an anomaly or not based on the determinations in operation (f).

According to embodiments of the invention, the one or more encoders may include two or more encoders, each trained to extract a different type of embedding, the method may include: in operation (b) clustering each type of embeddings separately; and in operation (e) assigning the examined speech sample to one cluster of each type.

According to embodiments of the invention, operation (g) may include determining that the examined speech sample is an anomaly if the examined speech sample is outside of the area enclosed by the decision boundary in each of the one or more clusters the examined speech sample is assigned to, and that the examined speech sample is not an anomaly otherwise.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanying drawings. Embodiments of the invention are illustrated by way of example and not limitation in the figures of the accompanying drawings, in which like reference numerals indicate corresponding, analogous or similar elements, and in which:

FIG. 1 depicts a system for clustering speech samples and finding a decision boundary for each cluster, according to embodiment of the invention.

FIG. 2 depicts a system for detecting synthetic speech, according to embodiment of the invention.

FIG. 3 depicts a system for clustering speech samples and finding a decision boundary for each cluster, according to embodiment of the invention.

FIG. 4 depicts a system for detecting synthetic speech, according to embodiment of the invention.

FIG. 5 is a graphical representation of a three-dimensional (3D) projection of an embedding subspace, according to embodiments of the invention.

FIG. 6 is a flowchart of a training phase of a method for detecting synthetic speech, according to embodiments of the invention.

FIG. 7 is a flowchart of a runtime phase of a method for detecting synthetic speech, according to embodiments of the invention.

FIG. 8 is a flowchart of a training phase of a method for detecting synthetic speech, according to embodiments of the invention.

FIG. 9 is a flowchart of a runtime phase of a method for detecting synthetic speech, according to embodiments of the invention.

FIG. 10 shows a high-level block diagram of an exemplary computing device which may be used with embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

According to embodiments of the invention, some components of the system such as encoders and classifiers may include one or more neural networks (NN). NNs are computing systems inspired by biological computing systems, but operating using manufactured digital computing technology. NNs are mathematical models of systems made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning or training proceeds typically using a loss function. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning using a loss function.

Some embodiments of the invention may include other deep architectures such as transformers, that may include series of layers of self-attention mechanisms and feedforward neural networks, used for processing input data. Transformers may be used in light of their capacity of parallelism and their multi-headed self-attention which facilitate features extraction.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example time delay neural network (TDNN) which is a multilayer artificial neural network that can be trained with shift-invariance in the coordinate space.

In practice, an NN, or NN learning, may be performed by one or more computing nodes or cores, such as generic central processing units or processors (CPUs, e.g. as embodied in personal computers), graphics processing units (GPUs), or tensor processing units (TPUs). which can be connected by a data network.

Embodiments of the invention may include clustering modules or classifiers used, for example, for clustering or classifying speech samples and for extracting or estimating metaproperties of a speaker from a speech sample of the speaker. Each of the clustering modules or classifiers may be pretrained to extract a certain metaproperty, and may include an ML model or algorithm including, for example, a supervised or unsupervised classification algorithm such as NNs, support vector machines (SVM), linear regression, logistic regression, naive Bayes, linear discriminant analysis, decision trees, k-nearest neighbor algorithm, similarity learning, etc. The metaproperties may include age, gender, skin tone, nationality, language, accent, location, and many more.

The voice or speech sample may include an audio recording of speech, provided in any applicable computerized audio format such as MP3, MP4, M4A, WAV, etc. As used herein, a real, authentic, genuine, natural, legitimate or bona fide speech sample may refer to a speech sample or a speech recording of a human speaker, and a spoofed, fake or synthetic speech may refer to a speech sample that is generated by a computer or a machine, utilizing, for example, generative AI and deep learning voice generation tools.

The speech samples and/or spectrograms (e.g., mel spectrograms) of the speech samples may be provided to one or more encoders (e.g., NNs) that may include any type of voice encoders, such as a prosody extractor, a speaker identity extractor, a speaker verification model, audio deep fake extractor, etc., that may each generate an embedding, e.g., a latent space vector, also referred to herein as a latent vector, a latent matrix, a signature or a feature vector, in a feed forward process, for each of the speech samples. As used herein, an embedding may include a reduced dimension (e.g., compressed) representation of the original data, generated for example by a machine learning (ML) model, a NN, or an encoder. The embedding may include a vector (e.g., an ordered list of values) or a matrix that represents the original data in a compressed form that, if generated properly, includes important or significant components or characteristics of the raw data.

Naïve methods for detecting synthetic speech requires training of an ML model on labeled training set of both spoofed and bona fide speech samples. After sufficient training, the trained ML model may be able to differentiate spoofed and bona fide speech samples. During runtime or inference, a speech sample (either spoofed or bona fide) may be provided to the trained ML model, and the ML model may produce a score. The score may be compared with a threshold to reach a classification result.

This approach for synthetic speech detection requires continuous model training. As new spoofing technologies emerge, the ML model may not recognize spoofed speech samples made using those new spoofing technologies. In this case, retraining of the ML model on speech samples produced using the new spoofing technologies may be necessary for the ML model to recognize them, or the development of new anti-spoofing technologies may be required. This results in a perpetual race where both spoofing and anti-spoofing technologies evolve and strive to outsmart each other. Thus, existing models require constant training; even if a model is effectively classifying spoofed and bona fide audio today, it is likely that within a year, its accuracy will diminish due to the rapid evolution of spoofing technologies, which continuously pose new challenges to anti-spoofing systems.

In addition, models frequently attempt to generalize based on the data they were trained on, which can often lead to limitations in performance. Given a model and an audio sample, the model processes the sample and generates a score indicating how closely the audio sample resembles spoofed speech. The decision to classify the audio sample as either spoofed or bona fide depends on a single threshold. However, this threshold can be restrictive; a specific threshold might work well for one type of spoofing technology but may not be optimal for another. As a result, compromising between different thresholds can lead to a suboptimal overall solution.

Embodiments of the invention may re-frame the anti-spoofing challenge as anomaly detection task by modeling the characteristics of natural human speech. Any deviation from this model may be classified as an anomaly or spoofed speech. Since natural speech evolves at a much slower pace than spoofing techniques, this approach may significantly reduce the need for frequent model maintenance and retraining. Furthermore, embodiments of the invention may implement multiple thresholds, each tailored to a specific type of speech (e.g., to a specific cluster, group or archetype of speakers), as opposed to using a single threshold for fake/non-fake classification. Thus, embodiments of the invention may improve the technology of neural networks, and of spoofed voice detection, by enhancing the robustness and adaptability of the solution.

In a preparation stage, embodiments of the invention may use a plurality of models or encoders (e.g., NNs), each of a different type, to extract features of a speech sample (e.g., an embedding) where each embedding may reflect qualities of the speech sample. For example, in one embodiment the following encoders may be used: speaker recognition encoder, prosody extractor and audio deep fake classifier. This list of encoders is exemplary only, and other models or encoders may be used. Each of the encoders may generate an embedding, and in some embodiments the embeddings may be unified to generate a single embedding for the audio sample, e.g., by concatenation, weighted average or any other applicable method.

Further in the preparation stage, one or more classifiers may be used to classify the speech sample into an archetype, e.g., into a class or a cluster of speakers with similar characteristics. The characteristics may include one or more of gender, age, skin tone, nationality, language, accent, location, etc. These characteristics may be extracted using pre-trained classifier models, or using any applicable method. Additionally or alternatively, unsupervised clustering algorithms may be used to build a dictionary of clusters representing speakers' archetypes which may represent clusters of bona fide speech.

Once classification is made, an embedding subspace, also referred to as a latent subspace, including the embeddings of the audio samples included in the cluster is defined. Next, a decision boundary (e.g., a threshold) may be found for each cluster or embedding subspace. The decision boundary may be defined with relation to a center of the cluster e.g., a center point or a mean of the embeddings included in the embedding subspace, within the embedding subspace. For example, the decision boundary may be defined by a distance radius measured from the center of the cluster. The decision boundary may enclose the region in the embedding subspace that includes embeddings of bona fide speech samples. Thus, embeddings that are outside of the region enclosed by the decision boundary may be identified as anomalies.

During inference, embodiments of the invention may generate an embedding for an examined speech sample using the same plurality of models used in the preparation stage, and may classify the examined speech sample to an embedding subspace using the same one or more classifiers used in the preparation stage. Then, classification of the examined speech sample to bona fide or synthetic speech may be performed with relation to the decision boundary in the cluster or embedding subspace to which the examined speech sample is classified to. For example, if the embedding of the examined speech sample is within the space enclosed by the decision boundary in the embedding subspace, then the examined speech sample may be considered bona fide. If, however, the embedding of the examined speech sample in the space of the embedding subspace that is outside of the are enclosed by the decision boundary, the examined speech sample may be considered as an outlier, which in the context of embodiments of the invention, may imply that the examined speech sample includes spoofed or synthetic speech.

Since details of speech such as tempo, pronunciation patterns, intonation etc., are different per language it may be necessary to build speaker architypes (e.g., clusters of speech samples, embedding subspaces and decision boundaries) per language. In production, embodiments may include a language detection model that may be used to detect the language in the speech sample and address it to the subgroup of speaker architypes designed for that language.

Embodiments of the invention may provide a system and method for detecting synthetic speech including, in a training or preparation phase, generating a embedding for each of a plurality of bona fide speech samples by providing each of the plurality of bona fide speech samples to one or more encoders, classifying or clustering the embeddings to a plurality of clusters, e.g., based on metaproperties of the bona fide speech samples, and determining a decision boundary for each of the plurality of clusters. During runtime, embodiments of the invention may include generating an embedding for an examined speech sample by providing the examined speech sample to the one or more encoders, assigning the examined speech sample to one of the plurality of clusters, e.g., based on metaproperties of the examined speech sample, and determining that the examined speech sample includes synthetic speech if the examined speech sample is outside of the decision boundary, and that the examined speech sample is bona fide or natural if the examined speech sample is within the decision boundary.

Embodiments of the invention may improve the technology of spoofed or synthetic voice detection by using a plurality of models or encoders to extract features of speech samples. This may enable increased flexibility and relatively easy adjustment to new spoofing technologies. According to embodiments of the invention, in case new spoofing technologies emerge, a new encoder, dedicated and trained for the mission of detecting the new type of spoofed speech, may be added to the already existing encoders. This may require training of the new model, and updating of the embedding subspaces and decision boundaries in the various clusters, which is simpler and requires less computational power than retraining a large encoder intended for identify all types of spoofed calls using a single model. Using already trained and verified models alongside new ones, reduces the complexity and computational power required for training new and larger modes, while keeping the accuracy of the entire system high, since the old and already proven models are still used. Embodiments of the invention may further improve the technology of spoofed or synthetic voice detection by using a plurality of thresholds (the decision boundaries), each designed to fit a specific cluster of speech samples. This may significantly increase the accuracy of spoofed speech detection.

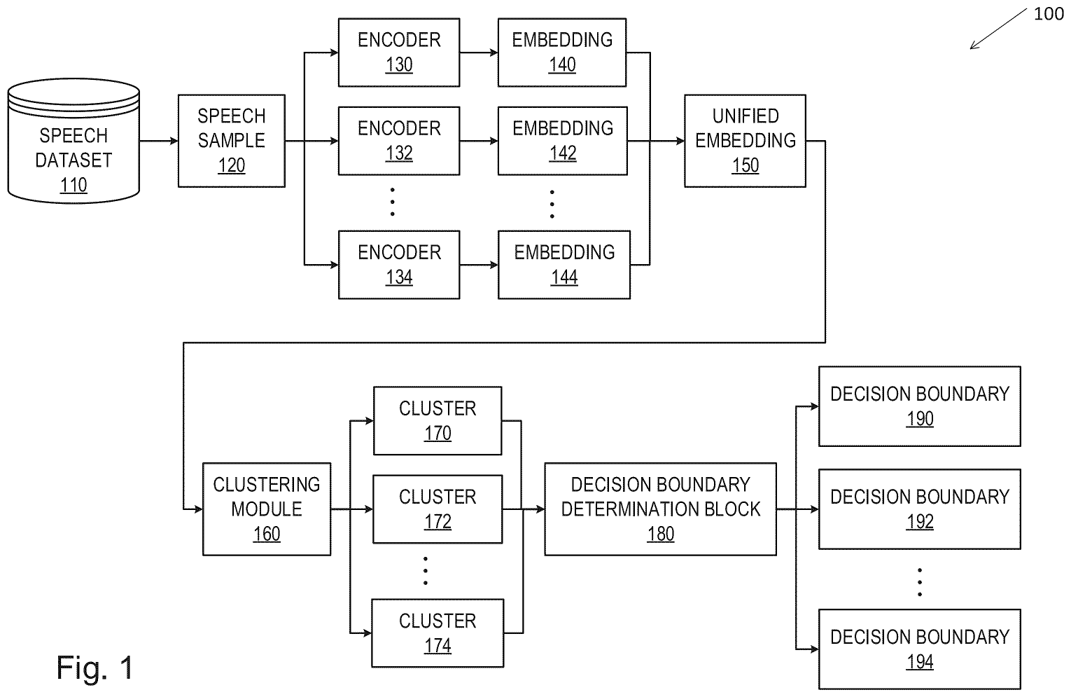

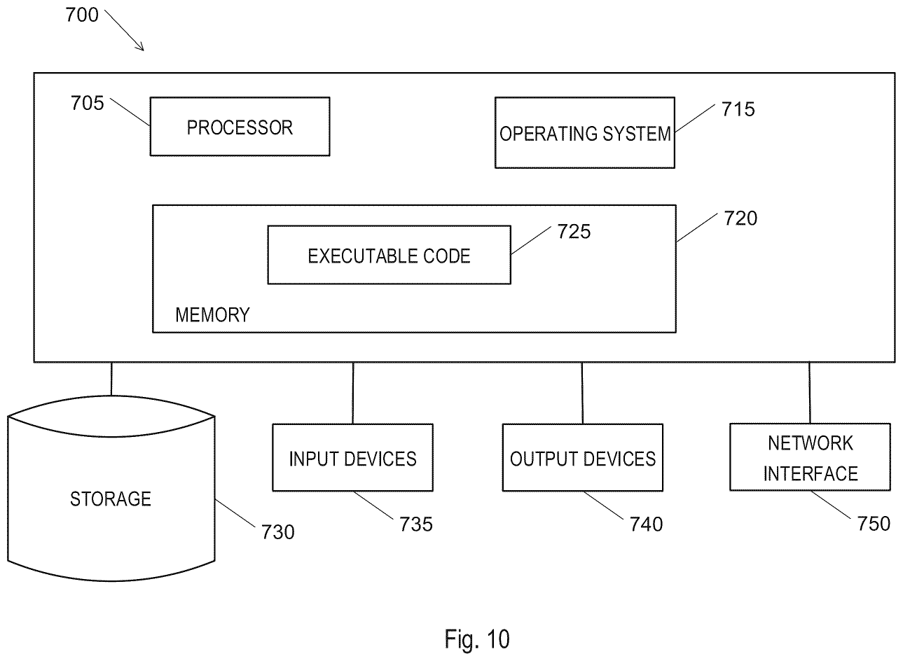

Reference is made to FIG. 1, which depicts a system 100 for clustering speech samples and finding a decision boundary for each cluster, according to embodiments of the invention. It should be understood in advance that the components and functions shown in FIG. 1 are intended to be illustrative only and embodiments of the invention are not limited thereto. While in some embodiments of the system of FIG. 1 are implemented using systems as shown in FIG. 10, in other embodiments other systems and equipment can be used.

Speech dataset 110 may include bona fide speech samples 120, e.g., each speech sample 120 may include an audio recording of a real person speaking. Dataset 110 may be stored, for example, on storage 730 presented in FIG. 10.

Each of encoders 130-134 may be configured to obtain speech sample 120) or a representation of speech sample 120 such as a spectrogram or a mel spectrogram of speech sample 120) and to generate, estimate, calculate or extract an embedding 140-144 also referred to as voice embedding. Each of encoders 130-134 may bottleneck speech sample 120 to obtain a reduced dimension representation of speech sample 120 that may presumably represent a subgroup of characteristics of speech sample 120. Each of encoders 130-134 may include a different type of encoder, trained for generating, estimating, calculating or extracting a different type of embedding 140-144. For example, encoder 130 may include a speaker verification encoder trained to generate embedding 140 that may include a speaker verification embedding, encoder 132 may include a prosody extraction encoder trained to generate embedding 142 that may include a prosody embedding, and encoder 134 may include an audio deep fake classifier trained to generate embedding 144 that may include a deep fake classification embedding. As used herein, prosody may refer to the rhythm or tempo, stress, pronunciation patterns and intonation of speech. More or other types of encoders 130-134 may be used. Each of encoders 130-134 may be trained independently of the other encoders, in different times and with different training datasets. Some of encoders 130-134 may include propriety or of-the-shelf encoders. For example, one of encoders 130-134 may include a speaker verification encoder that is already trained for speaker verification tasks, and is reused in system 100 for detecting synthetic speech. As mentioned elsewhere herein, new encoders 130-134 may be added to system 100 as required.

Embeddings 140-144 may be unified or combined to generate a single unified embedding 150. Embeddings 140-144 may be unified using any applicable method, including concatenating, adding, performing an average or weighted average, or performing other mathematical or logical operations to unite embeddings 140-144 into unified embedding 150.

Clustering module 160 may cluster unified embedding 150 to a plurality of clusters 170-174. Clustering module 160 may cluster unified embedding 150 based on metaproperties of the speakers in a speech samples 120, using a classifier, or a combination thereof. Clustering unified embedding 150 based on metaproperties of the speaker in speech sample 120 may include estimating a plurality of metaproperties of the speaker in speech sample 120 using pre-trained classifiers, and assigning speech sample 120 to clusters 170-174 based on the metaproperties. For example, speech samples 120 may be assigned to clusters 170-174 by assigning speech samples 120 with identical metaproperties to a single cluster. The metaproperties of the speaker in speech sample 120 may include, for example, gender, age, skin tone, language, nationality, accent and location of the speaker. Other or more metaproperties may be used. Additionally or alternatively, clustering may be performed by applying a classifier to unified embedding 150. Classification based on metaproperties and classification using a classifier may be combined. For example, speech samples may be first classified based on metaproperties and further classified within each cluster using a classifier. Once classification is made, an embedding subspace including the embeddings of the speech sample 120 included in the cluster is defined.

Decision boundary determination block 180 may calculate or determine a decision boundary 190-194 for each of clusters 170-174 or embedding subspaces of clusters 170-174, e.g., decision boundary 190 for cluster 170, decision boundary 192 for cluster 172, decision boundary 194 for cluster 174, etc. A decision boundary 190-194 of a cluster 170-174 may define or enclose a region in the embedding subspace of the cluster 170-174 that includes embeddings of bona fide speech samples, e.g., unified embeddings 150 that are included or located within the area enclosed by the decision boundary 190-194 may be considered natural or bona fide, and unified embeddings 150 that are included or located outside of the area enclosed by the decision boundary 190-194 may be considered outliers, e.g., suspected as spoofed or synthetic speech. Each of decision boundaries 190-194 may be defined with relation to a center of its associated cluster 170-174 within the embedding subspace, by a distance radius measured from the center of the cluster 170-174. For example, a center point of a cluster C may equal a mean of the unified embeddings 150 included in the embedding subspace:

$$μ ( C ) = \frac{{\sum }_{∀ x ∈ C} d ( c , x )}{n}$$

The distance radius may equal the standard deviation (STD) of the unified embeddings 150 included in the embedding subspace:

$$σ ( C ) = \sqrt{\frac{{\sum }_{∀ x ∈ C} {d ( c , x )}^{2}}{n}}$$

And the decision boundary 190-194 may equal:

$$Th ( C ) = μ ( C ) + α * σ ( C )$$

Where C is the cluster center, X is the embeddings associated within this cluster, n is the number of embeddings within a cluster, and d is the distance function (ex. Euclidean distance). α may include a variable used to adjust the expected false positive vs. false negative levels, e.g., mitigate between more strict systems that identify more attacks, e.g., cases of synthetic speech, on the expense of user experience (e.g., reduce the false negative levels on the expense of higher levels of false positive identification) or more loose systems that allow for some attacks to happen but having a better user experience (e.g., increase the false negative levels and reduce the levels of false positive identifications).

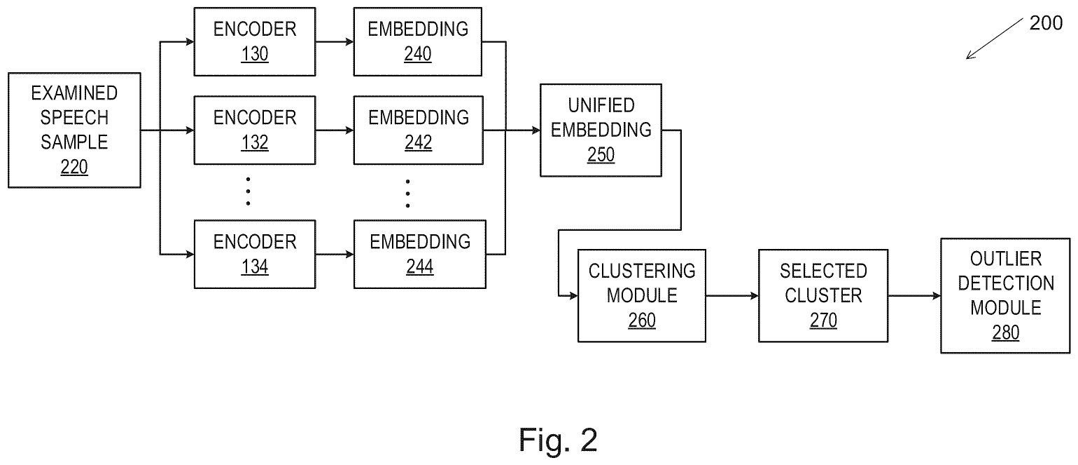

Reference is made to FIG. 2, which depicts a system 200 for detecting synthetic speech, according to embodiments of the invention. It should be understood in advance that the components and functions shown in FIG. 2 are intended to be illustrative only and embodiments of the invention are not limited thereto. While in some embodiments of the system of FIG. 2 are implemented using systems as shown in FIG. 10, in other embodiments other systems and equipment can be used. Detecting synthetic speech may be used in an inference stage, also referred to as runtime. Some of the components in FIG. 2 may be similar to components in FIG. 1, those components will be given the same reference numerals and will not be described again in detail.

An examined speech sample 220, e.g., a speech sample that should be verified by system 200, may be provided to encoders 130-134 (e.g., the same encoders 130-134 used in the training phase by system 100) to produce or generate embeddings 240-244 of examined speech sample 220, that may be unified or combined to generate a single unified embedding 250 of examined speech sample 220. Unified embedding 250 may be provided to clustering module 260 that may assign examined speech sample 220 to a selected cluster 270 of the plurality of clusters 170-174 (e.g., to one of the clusters generated by clustering module 160 in the training phase). Clustering module 260 may assign examined speech sample 220 to selected cluster 270 based on metaproperties of the speaker in examined speech sample 220, or using a classifier, or a combination thereof, similarly to clustering module 160. For example, if clustering has been performed by clustering module 160 based on metaproperties, then clustering module 260 may extract or estimate the same type of metaproperties used by clustering module 160 from examined speech sample 220, and assign examined speech sample 220 to one of clusters 170-174 that includes unified embeddings 150 of speech samples 120 with the same metaproperties. Similarly, if clustering has been performed by clustering module 160 using a classifier, a classifier may be used to assign examined speech sample 220 to one of clusters 170-174.

Outlier detection module 280 may determine whether examined speech sample 220 includes synthetic or bona fide speech, e.g., based on the location of unified embedding 250 with relation to the area defined by the decision boundary in the embedding subspace of the selected cluster 270. For example, outlier detection module 280 may determine that examined speech sample 220 includes synthetic speech if unified embedding 250 is outside of the decision boundary of the selected cluster 270, and that examined speech sample 220 is natural, genuine or bona fide speech if unified embedding 250 is within the area enclosed by the decision boundary of the selected cluster 270.

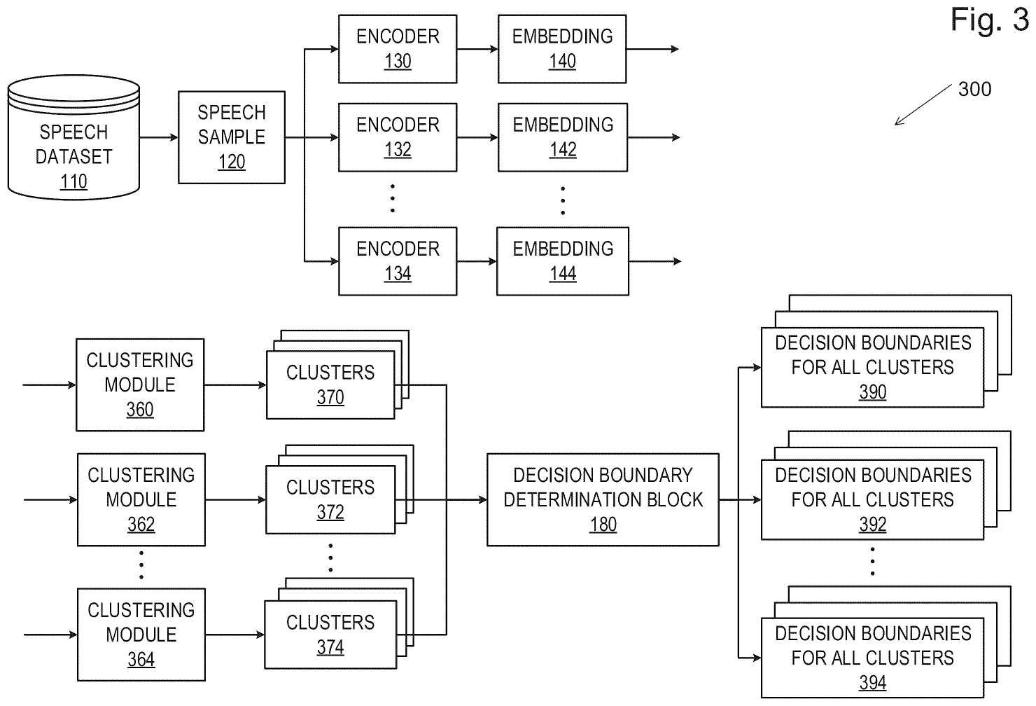

Reference is made to FIG. 3, which depicts a system 300 for clustering speech samples and finding a decision boundary for each cluster, according to embodiments of the invention. It should be understood in advance that the components and functions shown in FIG. 3 are intended to be illustrative only and embodiments of the invention are not limited thereto. While in some embodiments of the system of FIG. 3 are implemented using systems as shown in FIG. 10, in other embodiments other systems and equipment can be used. Some of the components in FIG. 3 may be similar to components in FIG. 1, those components will be given the same reference numerals and will not be described again in detail.

In system 300, embeddings 140-144 may not be unified. Instead, a plurality of clustering modules 360-364, may cluster each type of embeddings 140-144 separately. For example, clustering module 360 may cluster embeddings 140 generated by encoder 130 to a plurality of clusters 370, clustering module 362 may cluster embeddings 142 generated by encoder 132 to a plurality of clusters 372 and clustering module 364 may cluster embeddings 144 generated by encoder 134 to a plurality of clusters 374. Similarly to system 100, clustering may be performed based on metaproperties of the speakers in a speech samples 120, using a classifier, or a combination thereof. Decision boundary determination block 180 may calculate or determine a decision boundary 390-394 for each of clusters 370-374 or embedding subspaces of clusters 370-374, e.g., decision boundaries 390 for clusters 370, decision boundaries 392 for clusters 372, decision boundaries 394 for clusters 374, etc., such that each cluster may have its own decision boundary.

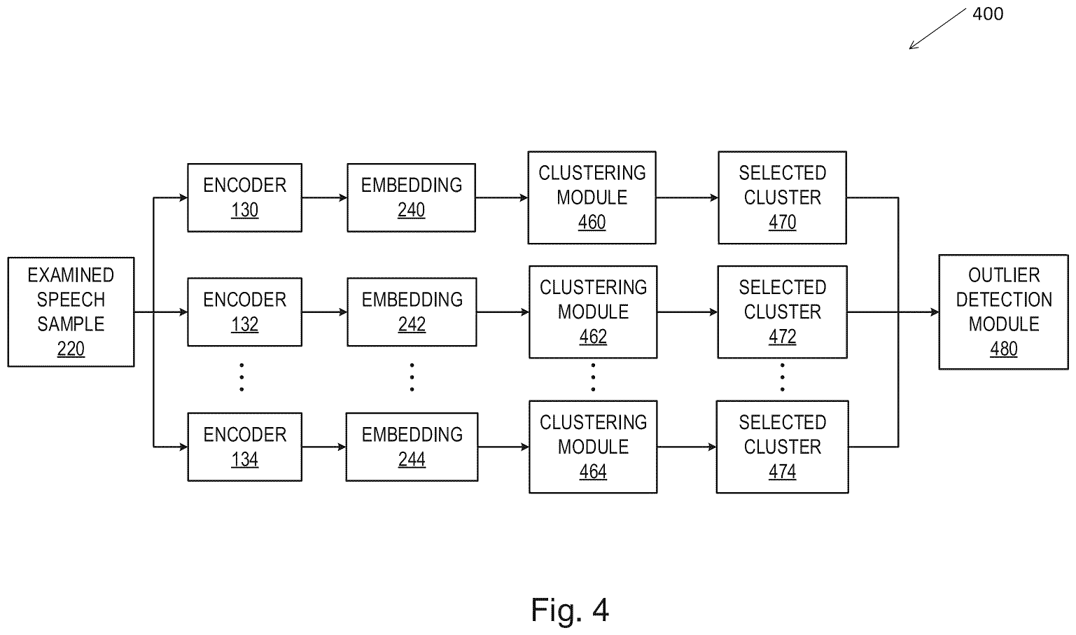

Reference is made to FIG. 4, which depicts a system 400 for detecting synthetic speech, according to embodiments of the invention. It should be understood in advance that the components and functions shown in FIG. 4 are intended to be illustrative only and embodiments of the invention are not limited thereto. While in some embodiments of the system of FIG. 4 are implemented using systems as shown in FIG. 10, in other embodiments other systems and equipment can be used. Detecting synthetic speech may be used in an inference stage, also referred to as runtime. Some of the components in FIG. 4 may be similar to components in FIGS. 1 and 2, those components will be given the same reference numerals and will not be described again in detail.

An examined speech sample 220, e.g., a speech sample that should be verified by system 400, may be provided to encoders 130-134 (e.g., the same encoders 130-134 used in the training phase by system 300) to produce or generate embeddings 240-244 of examined speech sample 220. Each of embeddings 240-244 may be provided to one of clustering modules 460-464. Each of clustering modules 460-464 may assign examined speech sample 220 to a selected cluster 470-474 of the plurality of clusters 370-374, e.g., clustering module 460 may assign examined speech sample 220 to selected cluster 470 selected from clusters 370 generated by clustering module 360 in the training phase, clustering module 462 may assign examined speech sample 220 to selected cluster 472 selected from clusters 372 generated by clustering module 362 in the training phase, clustering module 464 may assign examined speech sample 220 to selected cluster 474 selected from clusters 374 generated by clustering module 364 in the training phase, etc. Each of clustering modules 460-464 may assign examined speech sample 220 to selected clusters 470-474 based on metaproperties of the speaker in examined speech sample 220, using a classifier, or a combination thereof, similarly to clustering modules 360-364.

Outlier detection module 480 may determine whether examined speech sample 220 includes synthetic or bona fide speech. For example, outlier detection module 480 may determine for each of selected clusters 470-474 that examined speech sample 220 is assigned to, whether examined speech sample 220 is outside or inside the area enclosed by decision boundary 390-394. Outlier detection module 480 may determine whether examined speech sample 220 is an anomaly or not, e.g., whether examined speech sample 220 includes synthetic or bona fide speech, based on the determinations of whether examined speech sample 220 is outside or inside the area enclosed by decision boundaries 390-394 of selected clusters 470-474. For example, Outlier detection module 480 may determine whether examined speech sample 220 is an anomaly only if it outside all decision boundaries 390-394 of all selected clusters 470-474, if it outside at least one of decision boundaries 390-394 of selected clusters 470-474, if it outside a certain percentage of decision boundaries 390-394 of selected clusters 470-474, or using any other logic.

In some embodiments, systems 100-400 may be duplicated for different languages or distinct accents. This is because details of speech such as tempo, pronunciation patterns, intonation etc., may be different per language. During inference, or runtime, a preliminary stage may include a language detection model that may detect or determine the language of the speaker in the plurality of bona fide speech samples 120 and in the examined speech sample 220 and may be used as a router to the correct implementation of systems 100-400 of the detected language.

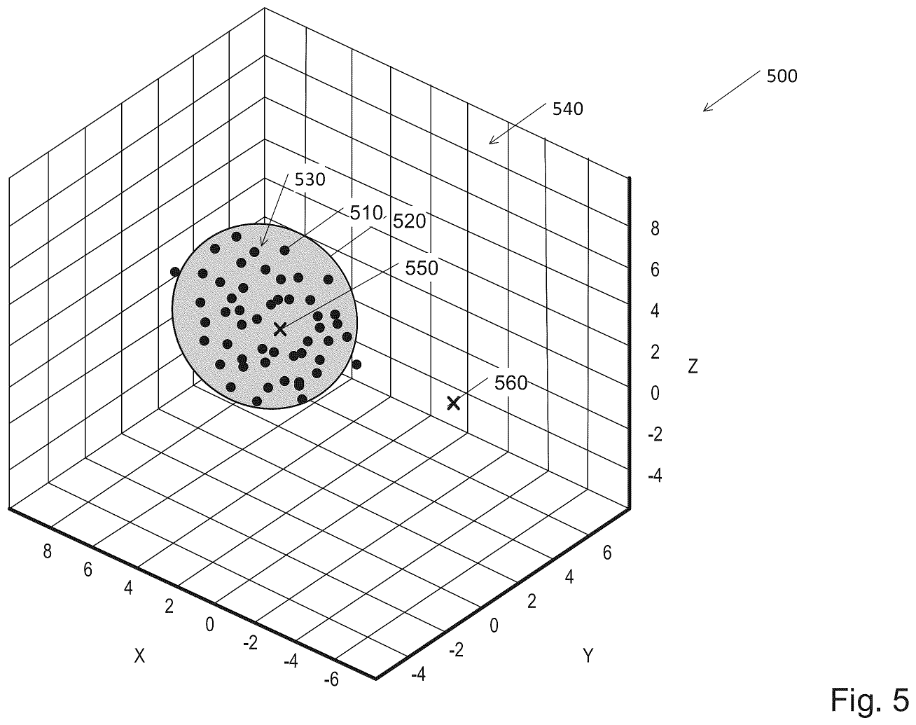

Reference is now made to FIG. 5, which is a graphical representation of a three-dimensional (3D) projection of an embedding subspace 500, according to embodiments of the invention. It is noted that the embedding subspace 500 presented in FIG. 5 is an example only, and that embedding subspaces according to embodiments of the invention may include higher dimensions. In addition, the embedding space of the cluster itself does not necessarily have to be spherical, but can take any form. Embedding subspace 500 may include embeddings 510, represented as black dots, of speech samples 120 used during the training phase, that pertain to a single cluster (e.g., any one of clusters 170-174 or 370-374). FIG. 5 also depicts the decision boundary 520 of embedding subspace 500, that encloses a region or area 530 in embedding subspace 500 that includes embeddings 510 of bona fide speech samples. FIG. 5 further depicts an embedding 550 of an examined speech sample that is clustered to embedding subspace 500 and is included within area 530, and therefore is considered as a bona fide speech sample, as well as an embedding 560 that is clustered to embedding subspace 500, but is located in an area 540 that is outside of decision boundary 520, and is therefore considered an outlier, e.g., suspected as spoofed or synthetic speech.

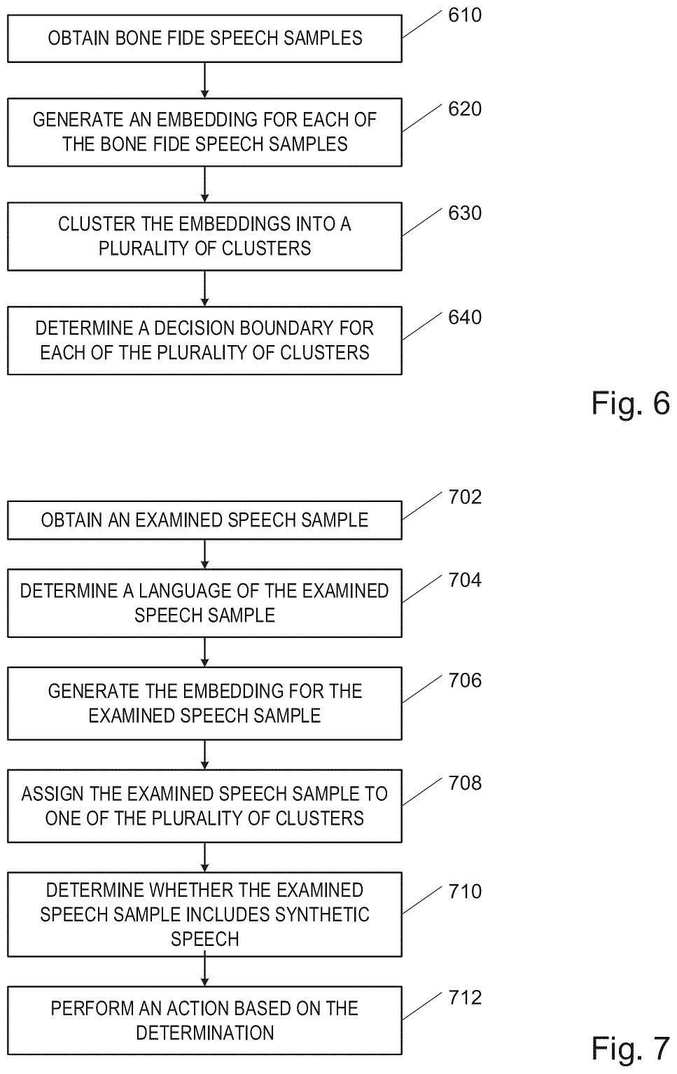

Reference is now made to FIG. 6, which is a flowchart of a training phase of a method for detecting synthetic speech, according to embodiments of the invention. While in some embodiments the operations of FIG. 6 are carried out using systems as shown in FIGS. 1 and 10, in other embodiments other systems and equipment can be used.

In operation 610, a processor (e.g., processor 705 depicted in FIG. 10 executing code to carry out a training phase of a method for detecting synthetic speech according to embodiments of the present invention) may obtain or receive a plurality of bona fide speech samples. In some embodiments, the bona fide speech samples obtained in operation 610 may all be in the same language or accent. The processor may obtain a recordings of the speech samples in any applicable computerized audio format, or other representations of the speech samples such as spectrograms and/or mel spectrograms of the speech samples. In operation 620, the processor may generate an embedding for each of the bona fide speech samples obtained in operation 610. In some embodiments, an embedding may be generated by one or more encoders, each trained to extract a different type of embedding, and unifying or combining the different types of embeddings into a unified embedding. Unifying the different types of embeddings may be performed by performing a mathematical or logical operations on the different types of embeddings, e.g., by concatenating the different types of embeddings, by performing a weighted average on the different types of embeddings, etc. In some embodiments, the one or more encodes may include a speaker verification encoder, a prosody extraction encoder and an audio deep fake classifier. Other types of encodes may be used.

In operation 630, the processor may cluster or classify the embeddings, e.g., the unified embeddings, into a plurality of clusters. Clustering or classifying the embeddings may be performed based on metaproperties of the speech samples and/or using a classifier. Clustering or classifying the embeddings performed based on metaproperties may include estimating a plurality of metaproperties of a speaker in a speech sample of the plurality of bona fide speech samples using pre-trained classifiers, and assigning each of the plurality of bona fide speech samples to clusters based on the metaproperties, e.g., assigning speech samples (or embeddings of the speech samples) with identical or similar metaproperties to a single cluster. The metaproperties may include, for example, gender, age, skin tone, nationality, language, accent and location. Other metaproperties may be used.

In operation 640, the processor, may determine a decision boundary for each of the plurality of clusters. The decision boundary may define the region in the embedding subspace that includes embeddings of bona fide speech samples. In some embodiments, the decision boundary may be defined by a center of the cluster and a distance radius measured from the center. For example, the center of the cluster may be a mean of the unified embedding within the cluster, and the distance radius may be related to the STD of the distances of the unified embeddings from the center of the cluster.

In some embodiments, operations 610-640 may be repeated for different languages and distinct accents, such that each supported language or accent may have its own set of embedding subspaces and decision boundaries. In addition, a new encoder may be added by, in operation 620 generating embeddings using the new encoder only, unifying the new embeddings with the previously existing embeddings, and repeating operations 630-640.

Reference is now made to FIG. 7, which is a flowchart of a runtime phase of a method for detecting synthetic speech, according to embodiments of the invention. While in some embodiments the operations of FIG. 7 are carried out using systems as shown in FIGS. 2 and 10, in other embodiments other systems and equipment can be used.

In operation 702, a processor (e.g., processor 705 depicted in FIG. 10 executing code to carry out a runtime phase of a method for detecting synthetic speech according to embodiments of the present invention) may obtain or receive an examined speech sample. The processor may obtain a recording of the examined speech sample in any applicable computerized audio format, or other representations of the examined speech sample such as spectrograms and/or mel spectrograms of the speech samples, similarly to operation 610. In operation 704, the processor may determine or detect a language of the examined speech sample, using any applicable method. The processor may determine or route the examined speech sample to the set of embedding subspaces and decision boundaries of the detected language. Operation 704 is optional and may be omitted if operations 610-640 are performed for all languages together or if the language of the examined speech sample is known to be the same as the language of to the set of embedding subspaces and decision boundaries used.

In operation 706, the processor may generate an embedding for the examined speech sample, using the exact same method as in operation 620 of the preparation phase. In operation 708, the processor may assign the examined speech sample to one of the plurality of clusters generated in operation 630, e.g., based on metaproperties (e.g., metaproperties may be extracted from the examined speech sample and the examined speech sample may be assigned to a cluster with the same metaproperties) and/or using a classifier. In operation 710, the processor may determine whether the examined speech sample includes synthetic or bona fide speech based on the location of the embedding of the examined speech sample in the embedding subspace of the cluster selected in operation 708 with relation to the decision boundary of that cluster. For example, the processor may determine that the examined speech sample includes synthetic speech if the examined speech sample is outside of an area enclosed by the decision boundary, and that the examined speech sample is bona fide or natural if the examined speech sample is within the area enclosed by the decision boundary.

In operation 712 the processor may take an action related to dealing with synthetic speech upon detecting or determining that the examined speech sample is a synthetic speech sample. For example, the processor may provide a notice to a human user, e.g., a system administrator, indicating that the examined speech sample is suspected as being a synthetic speech sample. The notice may further include details of the examined speech sample that is suspected as including synthetic speech, such as details related to a call from which the examined speech sample was recorded, such as the time of the call, the originator of the call, the alleged identity of the caller, transcript of the call, etc. In some call centers, the processor may inform the agent of the call center that the caller is suspected as spoofed, e.g., including synthetic speech and instruct the agent to ask a series of security questions to further investigate the caller, e.g., to verify the identity of the caller or to fully understand which information the attacker knows. The processor may also stop the call from which the examined speech sample was recorded or initiate further investigations.

In some embodiments, operations 610 and 820-840 may be repeated for different languages and distinct accents, such that each supported language or accent may have its own set of embedding subspaces and decision boundaries. In addition, a new encoder may be added by, in operation 820 generating embeddings using the new encoder only and performing operations 630-640 for the new embeddings only.

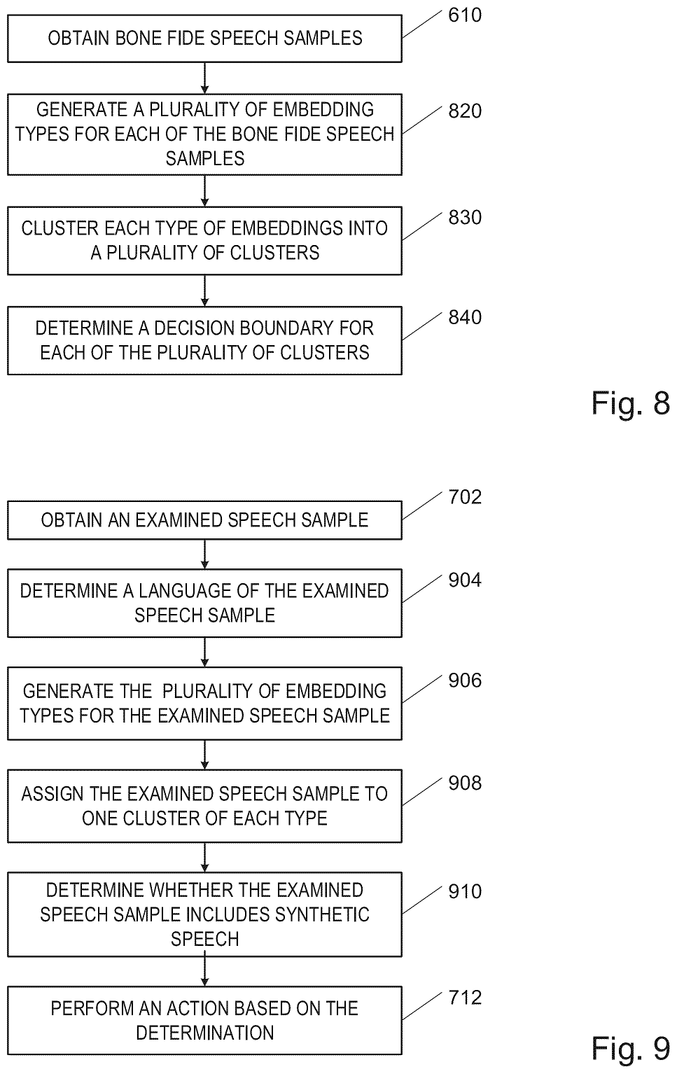

Reference is now made to FIG. 8, which is a flowchart of a training phase of a method for detecting synthetic speech, according to embodiments of the invention. While in some embodiments the operations of FIG. 8 are carried out using systems as shown in FIGS. 3 and 10, in other embodiments other systems and equipment can be used.

In operation 610, a processor (e.g., processor 705 depicted in FIG. 10 executing code to carry out a training phase of a method for detecting synthetic speech according to embodiments of the present invention) may obtain or receive a plurality of bona fide speech samples. In some embodiments, the bona fide speech samples obtained in operation 610 may all be in the same language or accent. The processor may obtain a recording of the speech samples in any applicable computerized audio format, or other representations of the speech samples such as spectrograms and/or mel spectrograms of the speech samples. In operation 820, the processor may generate a plurality of embeddings for each of the bona fide speech samples obtained in operation 610, where each of the embeddings of a single bona fide speech sample may be generated by a type of encoder trained to extract a certain type of embedding. In some embodiments, the one or more encodes may include the following types of encoders: a speaker verification encoder, a prosody extraction encoder and an audio deep fake classifier. Other types of encodes may be used.

In operation 830, the processor, may cluster or classify each group of embeddings that pertain to the same type of embedding into a plurality of clusters. Clustering or classifying the embeddings may be performed based on metaproperties of the speech samples and/or using a classifier. Clustering or classifying the embeddings performed based on metaproperties may include estimating a plurality of metaproperties of a speaker in a speech sample of the plurality of bona fide speech samples using pre-trained classifiers, and assigning each of the plurality of bona fide speech samples to clusters based on the metaproperties, e.g., assigning embeddings of speech samples with identical metaproperties to a single cluster. The metaproperties may include, for example, gender, age, skin tone, nationality, language, accent and location. Other metaproperties may be used.

In operation 840, the processor, may determine a decision boundary for each of the plurality of clusters. The decision boundary may define the region or area in the embedding subspace that includes embeddings of bona fide speech samples. In some embodiments the decision boundary may be defined by a center of the cluster and a distance radius measured from the center. For example, the center of the cluster may be a mean of the unified embedding within the cluster, and the distance radius may be related to a STD of the distances of the unified embeddings within the cluster from the center of the cluster and to a variable used to adjust the expected false positive vs. false negative levels (e.g., a).

Reference is now made to FIG. 9, which is a flowchart of a runtime phase of a method for detecting synthetic speech, according to embodiments of the invention. While in some embodiments the operations of FIG. 9 are carried out using systems as shown in FIGS. 4 and 10, in other embodiments other systems and equipment can be used.

In operation 702, a processor (e.g., processor 705 depicted in FIG. 10 executing code to carry out a runtime phase of a method for detecting synthetic speech according to embodiments of the present invention) may obtain or receive an examined speech sample. The processor may obtain a recording of the examined speech sample in any applicable computerized audio format, or other representations of the examined speech sample such as spectrograms and/or mel spectrograms of the speech samples, similarly to operation 610. In operation 904, the processor may determine or detect a language of the examined speech sample, using any applicable method. The processor may determine or route the examined speech sample to the set of embedding subspaces and decision boundaries of the detected language. Operation 904 is optional and may be omitted if the language is one of the metaproperties, or if operations 610 and 820-840 are performed for all languages together or if the language of the examined speech sample is known to be the same as the language of to the set of embedding subspaces and decision boundaries used. In operation 906, the processor may generate the plurality of embedding types for the examined speech sample, using the exact same method as in operation 820 of the preparation phase. In operation 908, the processor may assign the examined speech sample to one cluster of each type of the plurality of clusters generated in operation 830, e.g., based on metaproperties (e.g., metaproperties may be extracted from the examined speech sample and the examined speech sample may be assigned to a cluster with the same metaproperties) and/or using a classifier. In operation 910, the processor may determine whether the examined speech sample includes synthetic or bona fide speech based on the location of the embedding of the examined speech sample in the embedding subspace of the clusters selected in operation 908 with relation to the decision boundary of those clusters. For example, the processor may determine, for each of the one or more clusters the examined speech sample is assigned to, whether the examined speech sample is outside or inside of the area enclosed by the decision boundary, and determine whether the examined speech sample is an anomaly or not, e.g., includes a synthetic or bona fide speech, based on the determinations. For example, the processor may determine that the examined speech sample is an anomaly if the examined speech sample is outside of the area enclosed by the decision boundary in each of, in one of, in a certain percentage of, the one or more clusters the examined speech sample is assigned to, and that the examined speech sample is not an anomaly otherwise. Other logic may be used.

In operation 712 the processor may take an action related to dealing with synthetic speech upon detecting or determining that the examined speech sample is a synthetic speech sample. For example, the processor may provide a notice to a human user, e.g., a system administrator, indicating that the examined speech sample is suspected as being a synthetic speech sample. The processor may also stop the call from which the examined speech sample was recorded or initiate further investigations.

FIG. 10 shows a high-level block diagram of an exemplary computing device which may be used with embodiments of the present invention. Computing device 700 may include a controller or processor 705 that may be or include, for example, one or more CPUs, GPUs, TPUs and/or a chip or any suitable computing or computational device, an operating system 715, a memory 720, a storage 730, input devices 735 and output devices 740. Each of modules and equipment such as encoders 130-134, clustering modules 160 and 360-364, decision boundary determination block 180, outlier detection modules 280 and 480 shown in FIGS. 1-4, or other modules described herein, may be executed by, a computing device such as included in FIG. 10 or specific components of FIG. 10, although various units among these entities may be combined into one computing device.

Operating system 715 may be or may include any code segment designed and/or configured to perform tasks involving coordination, scheduling, supervising, controlling or otherwise managing operation of computing device 700, for example, scheduling execution of programs. Memory 720 may be or may include, for example, a Random Access Memory (RAM), a read only memory (ROM), a Dynamic RAM (DRAM), a volatile memory, a non-volatile memory, a cache memory, or other suitable memory units or storage units. Memory 720 may be or may include a plurality of possibly different memory units. Memory 720 may store for example, instructions to carry out a method (e.g., code 725), and/or data such as model weights, etc.

Executable code 725 may be any executable code, e.g., an application, a program, a process, task or script. Executable code 725 may be executed by processor 705 possibly under control of operating system 715. For example, executable code 725 may when executed carry out methods according to embodiments of the present invention. For the various modules and functions described herein, one or more computing devices 700 or components of computing device 700 may be used. One or more processor(s) 705 may be configured to carry out embodiments of the present invention by for example executing software or code.

Storage 730 may be or may include, for example, a hard disk drive, a solid-state drive, a floppy disk drive, a Compact Disk (CD) drive, or other suitable removable and/or fixed storage unit. Data such as instructions, code, speech samples, parameters of encoders and classifiers etc. may be stored in a storage 730 and may be loaded from storage 730 into a memory 720 where it may be processed by processor 705. Some of the components shown in FIG. 10 may be omitted.

Input devices 735 may be or may include for example a mouse, a keyboard, a touch screen or pad or any suitable input device. Any suitable number of input devices may be operatively connected to computing device 700 as shown by block 735. Output devices 740 may include displays, speakers and/or any other suitable output devices. Any suitable number of output devices may be operatively connected to computing device 700 as shown by block 740. Any applicable input/output (I/O) devices may be connected to computing device 700, for example, a modem, printer or facsimile machine, a universal serial bus (USB) device or external hard drive may be included in input devices 735 or output devices 740. Network interface 750 may enable device 700 to communicate with one or more other computers or networks. For example, network interface 750 may include a wired or wireless NIC.

Embodiments of the invention may include one or more article(s) (e.g. memory 720 or storage 730) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention may be embodied in other specific forms using other details without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein. In some cases well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” can include, for example, “multiple” or “two or more”. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for detecting synthetic speech, the method comprising, using a processor:
in a training phase:
(a) generating an embedding for each of a plurality of bona fide speech samples by providing each of the plurality of bona fide speech samples to one or more encoders;
(b) clustering the embeddings into a plurality of clusters; and
(c) determining a decision boundary for each of the plurality of clusters;
during runtime:
(d) generating an embedding for an examined speech sample by providing the examined speech sample to the one or more encoders;
(e) assigning the examined speech sample to selected cluster of the plurality of clusters; and
(f) determining that the examined speech sample includes synthetic speech based on a location of the embedding of the examined speech sample with relation to the decision boundary in the selected cluster.

2. The method of claim 1, operation (f) comprises:
(f) determining that the examined speech sample includes synthetic speech if the embedding of the examined speech sample is outside of an area enclosed by the decision boundary, and that the examined speech sample is bona fide if the embedding of the examined speech sample is within the area enclosed by the decision boundary.

3. The method of claim 1, wherein the one or more encoders comprises two or more encoders, each trained to extract a different type of embedding, the method comprising:
in operation (a) combining the two or more embeddings of each of the plurality of bona fide speech samples; and
in operation (d) combining the two or more embeddings of the examined speech sample.

4. The method of claim 3, wherein the one or more encodes comprises a speaker verification encoder, a prosody extraction encoder and an audio deep fake classifier.

5. The method of claim 1, wherein clustering is performed on the embeddings using a classifier.

6. The method of claim 1, wherein clustering comprises:
estimating a plurality of metaproperties of a speaker in a speech sample of the plurality of bona fide speech samples using pre-trained classifiers; and
assigning each of the plurality of bona fide speech samples to clusters based on the metaproperties.

7. The method of claim 6, wherein assigning speech samples to clusters comprises assigning speech samples with identical metaproperties to a single cluster.

8. The method of claim 6, wherein the metaproperties are selected from the list consisting of:
gender, age, skin tone, nationality, accent and location.

9. The method of claim 1, wherein the decision boundary is defined by a center of the cluster and a distance radius measured from the center.

10. The method of claim 9, wherein the center of the cluster is a mean of the unified embedding within the cluster, and the distance radius is related to a mean and standard deviation (STD) of the distances of the unified embeddings within the cluster from the center of the cluster.

11. The method of claim 1, comprising determining a language of the speaker in the plurality of bona fide speech samples and in the examined speech sample, and repeating operations (a)-(f) for each language.

12. A method for detecting synthetic speech, the method comprising, using a processor:
in a training phase:
(a) extracting, using at least one voice encoder, at least one embedding for each of a plurality of genuine speech samples;
(b) clustering the plurality of embeddings to a plurality of clusters; and
(c) determining a decision boundary for each of the plurality of clusters;
during runtime:
(d) extracting, using the at least one voice encoder, at least one embedding for an examined speech sample;
(e) assigning the examined speech sample to one or more clusters of the plurality of clusters; and
(f) determining for each of the one or more clusters the examined speech sample is assigned to, whether the examined speech sample is outside or inside of an area enclosed by the decision boundary; and
(g) determining whether the examined speech sample is an anomaly or not based on the determinations in operation (f).

13. The method of claim 12, wherein the one or more encoders comprises two or more encoders, each trained to extract a different type of embedding, the method comprising:
in operation (b) clustering each type of embeddings separately; and
in operation (e) assigning the examined speech sample to one cluster of each type.

14. The method of claim 12, wherein operation (g) comprises determining that the examined speech sample is an anomaly if the examined speech sample is outside of the area enclosed by the decision boundary in each of the one or more clusters the examined speech sample is assigned to, and that the examined speech sample is not an anomaly otherwise.

15. A system for detecting synthetic speech, the system comprising:
a memory; and
a processor configured to:
in a training phase:
(a) generate an embedding for each of a plurality of bona fide speech samples by providing each of the plurality of bona fide speech samples to one or more encoders;
(b) cluster the embeddings into a plurality of clusters; and
(c) determine a decision boundary for each of the plurality of clusters;
during runtime:
(d) generate an embedding for an examined speech sample by providing the examined speech sample to the one or more encoders;
(e) assign the examined speech sample to selected cluster of the plurality of clusters; and
(f) determine that the examined speech sample includes synthetic speech based on a location of the embedding of the examined speech sample with relation to the decision boundary in the selected cluster.

16. The system of claim 15, operation (f) comprises:
(f) determining that the examined speech sample includes synthetic speech if the embedding of the examined speech sample is outside of an area enclosed by the decision boundary, and that the examined speech sample is bona fide if the embedding of the examined speech sample is within the area enclosed by the decision boundary.

17. The system of claim 15, wherein the one or more encoders comprises two or more encoders, each trained to extract a different type of embedding, and wherein the processor is configured to:
in operation (a) combine the two or more embeddings of each of the plurality of bona fide speech samples; and
in operation (d) combine the two or more embeddings of the examined speech sample.

18. The system of claim 15, wherein the processor is configured to cluster the embeddings using a classifier.

19. The system of claim 15, wherein the processor is configured to cluster the embeddings by:
estimating a plurality of metaproperties of a speaker in a speech sample of the plurality of bona fide speech samples using pre-trained classifiers; and
assigning each of the plurality of bona fide speech samples to clusters based on the metaproperties, and
wherein the processor is configured to assign speech samples to clusters by assigning speech samples with identical metaproperties to a single cluster.

20. The system of claim 15, wherein the processor is configured to determine a language of the speaker in the plurality of bona fide speech samples and in the examined speech sample, and to repeat operations (a)-(f) for each language.
